(19) United States
(12) Patent Application Publication
(10) Pub. No.: US 2026/0036784 A1
(43) Pub. Date: Feb. 5, 2026

(54) WIDE-ANGLE LENS ASSEMBLY

(71) Applicant: Asia Optical Co., Inc., Taichung (TW)

(72) Inventors: Chia-Hung Sun, Taichung (TW); Jian-Wei Lee, Taichung (TW)

(21) Appl. No.: 19/011,707

(22) Filed: Jan. 7, 2025

(30) Foreign Application Priority Data
Jul. 31, 2024 (TW) 113128528

(51) Int. Cl. G02B 9/64; G02B 13/06

(52) U.S. Cl. CPC G02B 9/64; G02B 13/06

(57) ABSTRACT

A wide-angle lens assembly includes a first, a second, a third, a fourth, a fifth, a sixth, a seventh, an eighth, a ninth, and a tenth lenses, all of which are arranged in order from an object side to an image side along an optical axis. The first lens is a meniscus lens with negative refractive power. The second lens is with refractive power. The third lens is with negative refractive power. The fourth, seventh, and ninth lenses are with positive refractive power. The fifth lens is a meniscus lens with refractive power and includes a concave surface facing the object side and a convex surface facing the image side. The sixth lens includes a convex surface facing the object side. The eighth lens includes a concave surface facing the image side. The tenth lens is with positive refractive power and includes a convex surface facing the object side.

### BACKGROUND OF THE INVENTION

### Field of the Invention

The present invention relates to a wide-angle lens assembly.

### Description of the Related Art

The current development trend of a wide-angle lens assembly is toward large field of view. Additionally, the wide-angle lens assembly is developed to have high resolution in accordance with different application requirements. However, the known wide-angle lens assembly can't satisfy such requirements. Therefore, the wide-angle lens assembly needs a new structure in order to meet the requirements of large field of view and high resolution at the same time.

### BRIEF SUMMARY OF THE INVENTION

The invention provides a wide-angle lens assembly to solve the above problems. The wide-angle lens assembly of the invention is provided with characteristics of an increased field of view, an increased resolution, and still has a good optical performance.

The wide-angle lens assembly in accordance with an exemplary embodiment of the invention includes a first lens, a second lens, a third lens, a fourth lens, a fifth lens, a sixth lens, a seventh lens, an eighth lens, a ninth lens, and a tenth lens, all of which are arranged in order from an object side to an image side along an optical axis. The first lens is a meniscus lens with negative refractive power. The second lens is with refractive power. The third lens is with negative refractive power. The fourth lens is with positive refractive power. The fifth lens is a meniscus lens with refractive power and includes a concave surface facing the object side and a convex surface facing the image side. The sixth lens is with refractive power and includes a convex surface facing the object side. The seventh lens is with positive refractive power. The eighth lens is with refractive power and includes a concave surface facing the image side. The ninth lens is with positive refractive power. The tenth lens is with positive refractive power and includes a convex surface facing the object side.

In another exemplary embodiment, the fifth lens is with positive refractive power and includes a fifth front lens and a fifth rear lens, wherein the fifth front lens is a biconcave lens with negative refractive power and includes a concave surface facing the object side and another concave surface facing the image side and the fifth rear lens is a biconvex lens with positive refractive power and includes a convex surface facing the object side and another convex surface facing the image side; the fifth front lens and the fifth rear lens are spaced apart without air gaps formed therebetween; the sixth lens is with negative refractive power and includes a sixth front lens and a sixth rear lens, wherein the sixth front lens is a biconvex lens with positive refractive power and includes a convex surface facing the object side and another convex surface facing the image side and the sixth rear lens is with negative refractive power and includes a concave surface facing the object side; and the sixth front lens and the sixth rear lens are spaced apart without air gaps formed therebetween.

In yet another exemplary embodiment, the sixth rear lens is a meniscus lens and further includes a convex surface facing the image side; the eighth lens is a biconcave lens with negative refractive power and further includes another concave surface facing the object side; the ninth lens includes a convex surface facing the image side; and the tenth lens is a biconvex lens and further includes another convex surface facing the image side.

In another exemplary embodiment, the wide-angle lens assembly satisfies at least one of following conditions: 6≤TTL/BFL≤9; 6≤TTL/IH≤10; 6.5≤TTL/f≤10.5; −7≤f1/f≤−3; 6≤f9/f≤15; Vd10≤21; 9≤(Vd1+Vd2+Vd3)/Vd4≤11; wherein TTL is an interval from an object side surface of the first lens to an image plane along the optical axis, BFL is an interval from an image side surface of the tenth lens to the image plane along the optical axis, IH is an image height of the wide-angle lens assembly, f is an effective focal length of the wide-angle lens assembly, f1 is an effective focal length of the first lens, f9 is an effective focal length of the ninth lens, Vd1 is an Abbe number of the first lens, Vd2 is an Abbe number of the second lens, Vd3 is an Abbe number of the third lens, Vd4 is an Abbe number of the fourth lens, and Vd10 is an Abbe number of the tenth lens.

In yet another exemplary embodiment, the sixth rear lens is a biconcave lens and further includes another concave surface facing the image side; the eighth lens is a meniscus lens and further includes a convex surface facing the object side; the ninth lens includes a concave surface facing the image side; and the tenth lens is a biconvex lens and further includes another convex surface facing the image side.

In another exemplary embodiment, the sixth rear lens is a biconcave lens and further includes another concave surface facing the image side; the eighth lens is a meniscus lens and further includes a convex surface facing the object side; the ninth lens includes a concave surface facing the image side; and the tenth lens is a meniscus lens and further includes a concave surface facing the image side.

In yet another exemplary embodiment, the first lens includes a convex surface facing the object side and a concave surface facing the image side; the second lens is a meniscus lens with negative refractive power and includes a convex surface facing the object side and a concave surface facing the image side; the third lens is a biconcave lens and includes a concave surface facing the object side and another concave surface facing the image side; the fourth lens is a biconvex lens and includes a convex surface facing the object side and another convex surface facing the image side; the seventh lens is a biconvex lens and includes a convex surface facing the object side and another convex surface facing the image side; the eighth lens is with negative refractive power; and the ninth lens includes a convex surface facing the object side.

The wide-angle lens assembly in accordance with another exemplary embodiment of the invention includes a first lens, a second lens, a third lens, a fourth lens, a fifth lens, a sixth lens, a seventh lens, an eighth lens, a ninth lens, and a tenth lens, all of which are arranged in order from an object side to an image side along an optical axis. The first lens is a meniscus lens with negative refractive power. The second lens is with refractive power and includes a convex surface facing the object side. The third lens is with negative refractive power. The fourth lens is with positive refractive power. The fifth lens is a meniscus lens with refractive power and includes a concave surface facing the object side and a convex surface facing the image side. The sixth lens is with refractive power and includes a convex surface facing the object side. The seventh lens is with positive refractive power. The eighth lens is with negative refractive power. The ninth lens is with refractive power and includes a convex surface facing the object side. The tenth lens is with positive refractive power and includes a convex surface facing the object side.

In another exemplary embodiment, the fifth lens is with positive refractive power and includes a fifth front lens and a fifth rear lens, wherein the fifth front lens is a biconcave lens with negative refractive power and includes a concave surface facing the object side and another concave surface facing the image side and the fifth rear lens is a biconvex lens with positive refractive power and includes a convex surface facing the object side and another convex surface facing the image side; the fifth front lens and the fifth rear lens are spaced apart without air gaps formed therebetween; the sixth lens is with negative refractive power and includes a sixth front lens and a sixth rear lens, wherein the sixth front lens is a biconvex lens with positive refractive power and includes a convex surface facing the object side and another convex surface facing the image side and the sixth rear lens is with negative refractive power and includes a concave surface facing the object side; and the sixth front lens and the sixth rear lens are spaced apart without air gaps formed therebetween.

In yet another exemplary embodiment, the sixth rear lens is a meniscus lens and further includes a convex surface facing the image side; the eighth lens includes a concave surface facing the object side; the ninth lens is a biconvex lens with positive refractive power and further includes another convex surface facing the image side; and the tenth lens is a biconvex lens and further includes another convex surface facing the image side.

In another exemplary embodiment, the wide-angle lens assembly satisfies at least one of following conditions: 6≤TTL/BFL≤9; 6≤TTL/IH≤10; 6.5≤TTL/f≤10.5; −7≤f1/f≤−3; 6≤f9/f≤15; Vd10≤21; 9≤(Vd1+Vd2+Vd3)/Vd4≤11; wherein TTL is an interval from an object side surface of the first lens to an image plane along the optical axis, BFL is an interval from an image side surface of the tenth lens to the image plane along the optical axis, IH is an image height of the wide-angle lens assembly, f is an effective focal length of the wide-angle lens assembly, f1 is an effective focal length of the first lens, f9 is an effective focal length of the ninth lens, Vd1 is an Abbe number of the first lens, Vd2 is an Abbe number of the second lens, Vd3 is an Abbe number of the third lens, Vd4 is an Abbe number of the fourth lens, and Vd10 is an Abbe number of the tenth lens.

In yet another exemplary embodiment, the sixth rear lens is a biconcave lens and further includes another concave surface facing the image side; the eighth lens includes a convex surface facing the object side; the ninth lens is a meniscus lens and further includes a concave surface facing the image side; and the tenth lens is a biconvex lens and further includes another convex surface facing the image side.

In another exemplary embodiment, the sixth rear lens is a biconcave lens and further includes another concave surface facing the image side; the eighth lens includes a convex surface facing the object side; the ninth lens is a meniscus lens and further includes a concave surface facing the image side; and the tenth lens is a meniscus lens and further includes a concave surface facing the image side.

In yet another exemplary embodiment, the first lens includes a convex surface facing the object side and a concave surface facing the image side; the second lens is a meniscus lens with negative refractive power and further includes a concave surface facing the image side; the third lens is a biconcave lens and includes a concave surface facing the object side and another concave surface facing the image side; the fourth lens is a biconvex lens and includes a convex surface facing the object side and another convex surface facing the image side; the seventh lens is a biconvex lens and includes a convex surface facing the object side and another convex surface facing the image side; the eighth lens includes a concave surface facing the image side; and the ninth lens is with positive refractive power.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a lens layout and optical path diagram of a wide-angle lens assembly in accordance with a first embodiment of the invention;

FIG. 2 is a lens layout and optical path diagram of a wide-angle lens assembly in accordance with a fourth embodiment of the invention;

FIG. 3 depicts a field curvature diagram of the wide-angle lens assembly in accordance with the fourth embodiment of the invention;

FIG. 4 depicts a distortion diagram of the wide-angle lens assembly in accordance with the fourth embodiment of the invention;

FIG. 5 depicts a spot diagram of the wide-angle lens assembly in accordance with the fourth embodiment of the invention;

FIG. 6 is a lens layout and optical path diagram of a wide-angle lens assembly in accordance with a fifth embodiment of the invention;

FIG. 7 depicts a field curvature diagram of the wide-angle lens assembly in accordance with the fifth embodiment of the invention;

FIG. 8 depicts a distortion diagram of the wide-angle lens assembly in accordance with the fifth embodiment of the invention;

FIG. 9 depicts a spot diagram of the wide-angle lens assembly in accordance with the fifth embodiment of the invention;

FIG. 10 is a lens layout and optical path diagram of a wide-angle lens assembly in accordance with a sixth embodiment of the invention;

FIG. 11 depicts a field curvature diagram of the wide-angle lens assembly in accordance with the sixth embodiment of the invention;

FIG. 12 depicts a distortion diagram of the wide-angle lens assembly in accordance with the sixth embodiment of the invention; and

FIG. 13 depicts a spot diagram of the wide-angle lens assembly in accordance with the sixth embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides a wide-angle lens assembly including a first lens, a second lens, a third lens, a fourth lens, a fifth lens, a sixth lens, a seventh lens, an eighth lens, a ninth lens, and a tenth lens. The first lens is a meniscus lens with negative refractive power. The second lens is with refractive power. The third lens is with negative refractive power. The fourth lens is with positive refractive power. The fifth lens is a meniscus lens with refractive power and includes a concave surface facing an object side and a convex surface facing an image side. The sixth lens is with refractive power and includes a convex surface facing the object side. The seventh lens is with positive refractive power. The eighth lens is with refractive power and includes a concave surface facing the image side. The ninth lens is with positive refractive power. The tenth lens is with positive refractive power and includes a convex surface facing the object side. The first lens, the second lens, the third lens, the fourth lens, the fifth lens, the sixth lens, the seventh lens, the eighth lens, the ninth lens, and the tenth lens are arranged in order from the object side to the image side along an optical axis.

The present invention provides another wide-angle lens assembly including a first lens, a second lens, a third lens, a fourth lens, a fifth lens, a sixth lens, a seventh lens, an eighth lens, a ninth lens, and a tenth lens. The first lens is a meniscus lens with negative refractive power. The second lens is with refractive power and includes a convex surface facing an object side. The third lens is with negative refractive power. The fourth lens is with positive refractive power. The fifth lens is a meniscus lens with refractive power and includes a concave surface facing the object side and a convex surface facing an image side. The sixth lens is with refractive power and includes a convex surface facing the object side. The seventh lens is with positive refractive power. The eighth lens is with negative refractive power. The ninth lens is with refractive power and includes a convex surface facing the object side. The tenth lens is with positive refractive power and includes a convex surface facing the object side. The first lens, the second lens, the third lens, the fourth lens, the fifth lens, the sixth lens, the seventh lens, the eighth lens, the ninth lens, and the tenth lens are arranged in order from the object side to the image side along an optical axis.

Referring to Table 1, Table 2, Table 4, Table 5, Table 7, Table 8, Table 10, Table 11, Table 13, Table 14, Table 16, and Table 17, wherein Table 1, Table 4, Table 7, Table 10, Table 13, and Table 16 show optical specification in accordance with a first, a second, a third, a fourth, a fifth, and a sixth embodiments of the invention, respectively, and Table 2, Table 5, Table 8, Table 11, Table 14, and Table 17 show aspheric coefficients of each aspheric lens in Table 1, Table 4, Table 7, Table 10, Table 13, and Table 16, respectively.

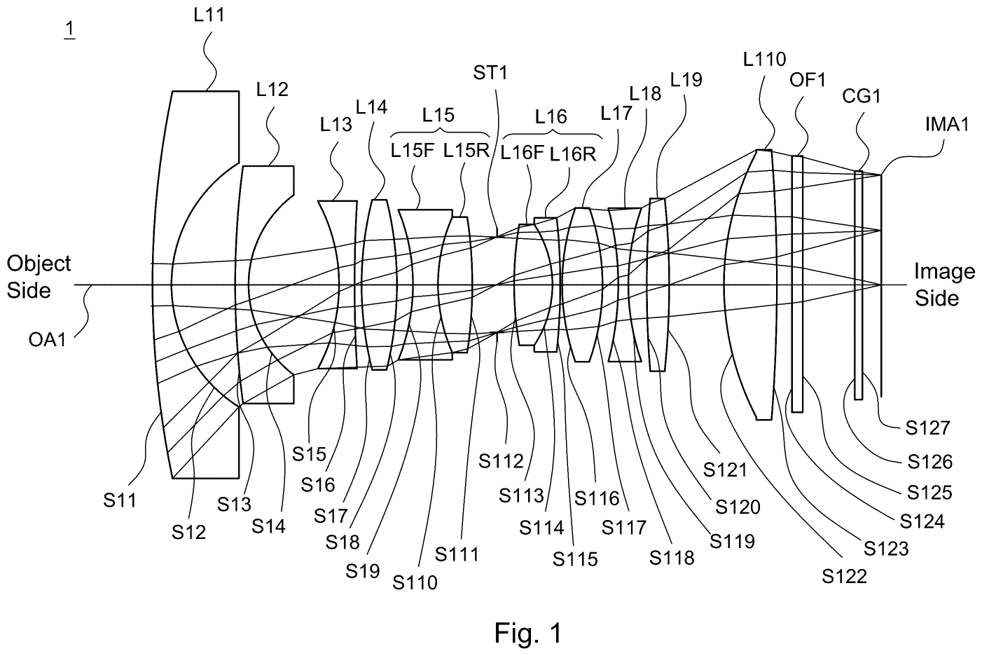

FIGS. 1, 2, 6, and 10 are lens layout and optical path diagrams of the lens assemblies in accordance with the first, fourth, fifth, and sixth embodiments of the invention, respectively. The figures which depict the lens layout and optical path diagram of the lens assemblies in accordance with the second and third embodiments of the invention are omitted. However, in the following content about the second and third embodiments, the element symbols of the second and third embodiments are still used for convenience of explanation.

The first lenses L11, L21, L31, L41, L51, L61 are meniscus lenses with negative refractive power, wherein the object side surfaces S11, S21, S31, S41, S51, S61 are convex surfaces, the image side surfaces S12, S22, S32, S42, S52, S62 are concave surfaces, and both of the object side surfaces S11, S21, S31, S41, S51, S61 and image side surfaces S12, S22, S32, S42, S52, S62 are spherical surfaces.

The second lenses L12, L22, L32, L42, L52, L62 are meniscus lenses with negative refractive power, wherein the object side surfaces S13, S23, S33, S43, S53, S63 are convex surfaces, the image side surfaces S14, S24, S34, S44, S54, S64 are concave surfaces, and both of the object side surfaces S13, S23, S33, S43, S53, S63 and image side surfaces S14, S24, S34, S44, S54, S64 are spherical surfaces.

The third lenses L13, L23, L33, L43, L53, L63 are biconcave lenses with negative refractive power, wherein the object side surfaces S15, S25, S35, S45, S55, S65 are concave surfaces, the image side surfaces S16, S26, S36, S46, S56, S66 are concave surfaces, and both of the object side surfaces S15, S25, S35, S45, S55, S65 and image side surfaces S16, S26, S36, S46, S56, S66 are spherical surfaces.

The fourth lenses L14, L24, L34, L44, L54, L64 are biconvex lenses with positive refractive, wherein the object side surfaces S17, S27, S37, S47, S57, S67 are convex surfaces, the image side surfaces S18, S28, S38, S48, S58, S68 are convex surfaces, and both of the object side surfaces S17, S27, S37, S47, S57, S67 and image side surfaces S18, S28, S38, S48, S58, S68 are spherical surfaces.

The fifth lenses L15, L25, L35, L45, L55, L65 are with positive refractive power, wherein the object side surfaces S19, S29, S39, S49, S59, S69 are concave surfaces, the image side surfaces S111, S211, S311, S411, S511, S611 are convex surfaces, and both of the object side surfaces S19, S29, S39, S49, S59, S69 and image side surfaces S111, S211, S311, S411, S511, S611 are spherical surfaces. The fifth lenses L15, L25, L35, L45, L55, L65 include the fifth front lenses L15F, L25F, L35F, LA5F, L55F, L65F and the fifth rear lenses L15R, L25R, L35R, LA5R, L55R, L65R. There is no air gap between the fifth front lenses L15F, L25F, L35F, L45F, L55F, L65F and the fifth rear lenses L15R, L25R, L35R, L45R, L55R, L65R or the fifth front lenses L15F, L25F, L35F, LA5F, L55F, L65F and the fifth rear lenses L15R, L25R, L35R, LA5R, L55R, L65R are cemented. The fifth front lenses L15F, L25F, L35F, LA5F, L55F, L65F are biconcave lenses with negative refractive power, wherein the object side surfaces S19, S29, S39, S49, S59, S69 are concave surfaces, the image side surfaces S110, S210, S310, S410, S510, S610 are concave surfaces, and both of the object side surfaces S19, S29, S39, S49, S59, S69 and image side surfaces S110, S210, S310, S410, S510, S610 are spherical surfaces. The fifth rear lenses L15R, L25R, L35R, L45R, L55R, L65R are biconvex lenses with positive refractive power, wherein the object side surfaces S110, S210, S310, S410, S510, S610 are convex surfaces, the image side surfaces S111, S211, S311, S411, S511, S611 are convex surfaces, and both of the object side surfaces S110, S210, S310, S410, S510, S610 and image side surfaces S111, S211, S311, S411, S511, S611 are spherical surfaces.

The sixth lenses L16, L26, L36, L46, L56, L66 are with negative refractive power, wherein the object side surfaces S113, S213, S313, S413, S513, S613 are convex surfaces and both of the object side surfaces S113, S213, S313, S413, S513, S613 and image side surfaces S115, S215, S315, S415, S515, S615 are spherical surfaces. The sixth lenses L16, L26, L36, L46, L56, L66 include the sixth front lenses L16F, L26F, L36F, LA6F, L56F, L66F and the sixth rear lenses L16R, L26R, L36R, L46R, L56R, L66R. There is no air gap between the sixth front lenses L16F, L26F, L36F, LA6F, L56F, L66F and the sixth rear lenses L16R, L26R, L36R, LA6R, L56R, L66R or the sixth front lenses L16F, L26F, L36F, L46F, L56F, L66F and the sixth rear lenses L16R, L26R, L36R, L46R, L56R, L66R are cemented. The sixth front lenses L16F, L26F, L36F, L46F, L56F, L66F are biconvex lenses with positive refractive power, wherein the object side surfaces S113, S213, S313, S413, S513, S613 are convex surfaces, the image side surfaces S114, S214, S314, S414, S514, S614 are convex surfaces, and both of the object side surfaces S113, S213, S313, S413, S513, S613 and image side surfaces S114, S214, S314, S414, S514, S614 are spherical surfaces. The sixth rear lenses L16R, L26R, L36R, LA6R, L56R, L66R are with negative refractive power, wherein the object side surfaces S114, S214, S314, S414, S514, S614 are concave surfaces and both of the object side surfaces S114, S214, S314, S414, S514, S614 and image side surfaces S115, S215, S315, S415, S515, S615 are spherical surfaces.

The seventh lenses L17, L27, L37, L47, L57, L67 are biconvex lenses with positive refractive power, wherein the object side surfaces S116, S216, S316, S416, S516, S616 are convex surfaces, the image side surfaces S117, S217, S317, S417, S517, S617 are convex surfaces, and both of the object side surfaces S116, S216, S316, S416, S516, S616 and image side surfaces S117, S217, S317, S417, S517, S617 are aspheric surfaces.

The eighth lenses L18, L28, L38, L48, L58, L68 are with negative refractive power, wherein the image side surfaces S119, S219, S319, S419, S519, S619 are concave surfaces and both of the object side surfaces S118, S218, S318, S418, S518, S618 and image side surfaces S119, S219, S319, S419, S519, S619 are spherical surfaces.

The ninth lenses L19, L29, L39, L49, L59, L69 are with positive refractive power, wherein the object side surfaces S120, S220, S320, S420, S520, S620 are convex surfaces and both of the object side surfaces S120, S220, S320, S420, S520, S620 and image side surfaces S121, S221, S321, S421, S521, S621 are spherical surfaces.

The tenth lenses L110, L210, L310, L410, L510, L610 are with positive refractive power, wherein the object side surfaces S122, S222, S322, S422, S522, S622 are convex surfaces and both of the object side surfaces S122, S222, S322, S422, S522, S622 and image side surfaces S123, S223, S323, S423, S523, S623 are spherical surfaces.

In addition, the lens assemblies 1, 2, 3, 4, 5, and 6 satisfy at least one of the following conditions (1)-(7):

$$6 \leq TTL / BFL \leq 9 ; \qquad ( 1 )$$

$$6 \leq TTL / IH \leq 10 ; \qquad ( 2 )$$

$$6.5 \leq TTL / f \leq 10.5 ; \qquad ( 3 )$$

$$- 7 \leq f 1 / f \leq - 3 ; \qquad ( 4 )$$

$$6 \leq f 9 / f \leq 15 ; \qquad ( 5 )$$

$$Vd 10 \leq 21 ; \qquad ( 6 )$$

$$9 \leq ( Vd 1 + Vd 2 + Vd 3 ) / Vd 4 \leq 11 ; \qquad ( 7 )$$

wherein: TTL is an interval from the object side surfaces S11, S21, S31, S41, S51, S61 of the first lenses L11, L21, L31, L41, L51, L61 to the image planes IMA1, IMA2, IMA3, IMA4, IMA5, IMA6 along the optical axes OA1, OA2, OA3, OA4, OA5, OA6 for the first to sixth embodiments; BFL is an interval from the image side surfaces S123, S223, S323, S423, S523, S623 of the tenth lenses L110, L210, L310, L410, L510, L610 to the image planes IMA1, IMA2, IMA3, IMA4, IMA5, IMA6 along the optical axes OA1, OA2, OA3, OA4, OA5, OA6 for the first to sixth embodiments; IH is an image height of the wide-angle lens assemblies 1, 2, 3, 4, 5, 6 for the first to sixth embodiments; f is an effective focal length of the wide-angle lens assemblies 1, 2, 3, 4, 5, 6 for the first to sixth embodiments; f1 is an effective focal length of the first lenses L11, L21, L31, L41, L51, L61 for the first to sixth embodiments; f9 is an effective focal length of the ninth lenses L19, L29, L39, L49, L59, L69 for the first to sixth embodiments; Vd1 is an Abbe number of the first lenses L11, L21, L31, L41, L51, L61 for the first to sixth embodiments; Vd2 is an Abbe number of the second lenses L12, L22, L32, L42, L52, L62 for the first to sixth embodiments; Vd3 is an Abbe number of the third lenses L13, L23, L33, L43, L53, L63 for the first to sixth embodiments; Vd4 is an Abbe number of the fourth lenses L14, L24, L34, L44, L54, L64 for the first to sixth embodiments; and Vd10 is an Abbe number of the tenth lenses L110, L210, L310, L410, L510, L610 for the first to sixth embodiments. With the wide-angle lens assemblies 1, 2, 3, 4, 5, 6 satisfying at least one of the above conditions (1)-(7), the field of view can be effectively increased, the resolution can be effectively increased, the aberration can be effectively corrected, and the chromatic aberration can be effectively corrected.

When the condition (1): 6≤TTL/BFL≤9 is satisfied, the assembly yield can be effectively increased and achieve basic operation. When the condition (2): 6≤TTL/IH≤10 is satisfied, the total lens length can be effectively shortened to achieve the purpose of miniaturization design and achieve basic operation. When the condition (3): 6.5≤TTL/f≤10.5 is satisfied, the back focal length can be effectively and reasonably shortened to achieve better miniaturization design and achieve basic operation. When the condition (4): −7≤f1/f≤−3 is satisfied, the aberration caused by the large light collection angle can be effectively decreased and achieve basic operation. When the condition (5): 6≤f9/f≤15 is satisfied, the field curvature can be effectively decreased and achieve basic operation. When the condition (6): Vd10≤21 is satisfied, the optical path can be effectively deflected to comply with the chief ray angle of the image plane, the volume of the wide-angle lens assembly can be effectively decreased, and achieve basic operation. When the condition (7): 9≤(Vd1+Vd2+Vd3)/Vd4≤11 is satisfied, the optical path from the first lens to the fourth lens can be effectively adjusted to balance the deflection of different wavelengths to reduce chromatic aberration and achieve basic operation.

The field of view can be effectively increased and the optical path can be effectively adjusted to prevent big bend in the light path when the first lens is a meniscus lens with negative refractive power. The optical path adjustment caused by the negative refractive power of the first lens can be effectively slowed to correct partial aberration when the second lens is a meniscus lens with negative refractive power. The aberration caused by the first lens and the second lens are with negative refractive power can be effectively corrected when the third lens is with negative refractive power. The optical path deflection caused by the negative refractive power of the first lens to the third lens can be adjusted when the fourth lens is with positive refractive power. The chromatic aberration can be effectively corrected when the fifth lens is a cemented lens. The chromatic aberration can be further corrected when the sixth lens is a cemented lens. The resolution of the peripheral field of view can be effectively increased when the seventh lens is an aspherical lens with positive refractive power. The astigmatism can be effectively decreased, the meniscus shape design helps to reduce manufacturing sensitivity, and has a good processing characteristics, when the eighth lens is with negative refractive power. The field curvature can be effectively decreased when the ninth lens is with positive refractive power. The optical path can be effectively adjusted to reduce the chief ray angle to meet the chief ray angle requirements of the image plane when the tenth lens is with positive refractive power.

A detailed description of a wide-angle lens assembly in accordance with a first embodiment of the invention is as follows. Referring to FIG. 1, the wide-angle lens assembly 1 includes a first lens L11, a second lens L12, a third lens L13, a fourth lens L14, a fifth lens L15, a stop ST1, a sixth lens L16, a seventh lens L17, an eighth lens L18, a ninth lens L19, a tenth lens L110, an optical filter OF1, and a cover glass CG1, all of which are arranged in order from an object side to an image side along an optical axis OA1. The fifth lens L15 is a cemented lens which is cemented by a fifth front lens L15F and a fifth rear lens L15R. The sixth lens L16 is a cemented lens which is cemented by a sixth front lens L16F and a sixth rear lens L16R. In operation, the light from the object side is imaged on an image plane IMA1.

According to the foregoing, wherein: the sixth rear lens L16R is a meniscus lens, wherein the image side surface S115 is a convex surface; the eighth lens L18 is a biconcave lens, wherein the object side surface S118 is a concave surface; the ninth lens L19 is a biconvex lens, wherein the image side surface S121 is a convex surface; the tenth lens L110 is a biconvex lens, wherein the image side surface S123 is a convex surface; both of the object side surface S124 and image side surface S125 of the optical filter OF1 are plane surfaces; and both of the object side surface S126 and image side surface S127 of the cover glass CG1 are plane surfaces; with the above design of the lenses, stop ST1, and at least one of the conditions (1)-(7) satisfied, the wide-angle lens assembly 1 can have an effective increased field of view, an effective increased resolution, an effective corrected aberration, and an effective corrected chromatic aberration.

Table 1 shows the optical specification of the wide-angle lens assembly 1 in FIG. 1.

TABLE 1
Effective Focal Length = 7.06 mm F-number = 2.40
Total Lens Length = 49.99 mm Field of View = 131.78 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S11 | 65.43 | 1.38 | 1.44 | 95.10 | −26.56 | L11 |
| S12 | 9.81 | 4.38 | | | | |
| S13 | 65.58 | 0.94 | 1.46 | 90.27 | −19.46 | L12 |
| S14 | 7.80 | 6.21 | | | | |
| S15 | −11.71 | 0.97 | 1.50 | 81.61 | −20.99 | L13 |
| S16 | 100.33 | 0.47 | | | | |
| S17 | 21.87 | 2.49 | 2.00 | 25.46 | 11.36 | L14 |
| S18 | −22.64 | 1.07 | | | | |
| S19 | −13.51 | 1.68 | 1.67 | 32.21 | −8.81 | L15 |
| | | | | | | L15F |
| S110 | 11.19 | 2.42 | 1.91 | 35.25 | 8.65 | L15R |
| S111 | −24.26 | 1.63 | | | | |
| S112 | ∞ | 1.19 | | | | ST1 |
| S113 | 21.94 | 2.64 | 1.50 | 81.61 | 11.480 | L16 |
| | | | | | | L16F |
| S114 | −7.42 | 0.52 | 1.85 | 25.15 | −10.70 | L16R |
| S115 | −39.49 | 0.10 | | | | |
| S116 | 14.73 | 2.87 | 1.62 | 63.85 | 10.85 | L17 |
| S117 | −11.49 | 0.99 | | | | |
| S118 | −21.16 | 0.68 | 1.85 | 25.15 | −9.95 | L18 |
| S119 | 14.60 | 1.27 | | | | |
| S120 | 88.84 | 1.46 | 1.60 | 60.60 | 58.73 | L19 |
| S121 | −58.83 | 3.83 | | | | |
| S122 | 19.61 | 3.58 | 1.95 | 17.94 | 17.75 | L110 |
| S123 | −114.08 | 1.00 | | | | |
| S124 | ∞ | 0.84 | 1.55 | 70.00 | | OF1 |
| S125 | ∞ | 3.60 | | | | |
| S126 | ∞ | 0.50 | 1.52 | 64.17 | | CG1 |
| S127 | ∞ | 1.28 | | | | |

The aspheric surface sag z of each aspheric surface in Table 1 can be calculated by the following formula:

$$z = c {h}^{2} / \{ 1 + {[ 1 - ( k + 1 ) {c}^{2} {h}^{2} ]}^{1 / 2} \} + {Ah}^{4} + B {h}^{6} + C {h}^{8} + D {h}^{10}$$

where c is curvature, h is the vertical distance from the lens surface to the optical axis, k is conic constant and A, B, C, and D are aspheric coefficients.

In the first embodiment, the conic constant k and the aspheric coefficients A, B, C, D of each aspheric lens are shown in Table 2.

TABLE 2

| Surface | | | | | |
|---|---|---|---|---|---|
| Number | k | A | B | C | D |
| S116 | −7.83308 | 0.000221 | −1.7E−06 | 4.77E−08 | −1.6E−09 |
| S117 | −1.34462 | 0.000131 | −6.3E−07 | 7.5E−08 | −2.5E−09 |

Table 3 shows the parameters and condition values for conditions (1)-(7) in accordance with the first embodiment of the invention. It can be seen from Table 3 that the wide-angle lens assembly 1 of the first embodiment satisfies the conditions (1)-(7).

TABLE 3

| BFL | 7.22 mm | IH | 7.46 mm | | |
|---|---|---|---|---|---|
| TTL/BFL | 6.92 | TTL/IH | 6.70 | TTL/f | 7.08 |
| f1/f | −3.76 | f9/f | 8.32 | Vd10 | 17.94 |

| | |
|---|---|
| (Vd1 + Vd2 + Vd3)/Vd4 | 10.49 |

A detailed description of a wide-angle lens assembly in accordance with a second embodiment of the invention is as follows. The wide-angle lens assembly 2 includes a first lens L21, a second lens L22, a third lens L23, a fourth lens L24, a fifth lens L25, a stop ST2, a sixth lens L26, a seventh lens L27, an eighth lens L28, a ninth lens L29, a tenth lens L210, an optical filter OF2, and a cover glass CG2, all of which are arranged in order from an object side to an image side along an optical axis OA2. The fifth lens L25 is a cemented lens which is cemented by a fifth front lens L25F and a fifth rear lens L25R. The sixth lens L26 is a cemented lens which is cemented by a sixth front lens L26F and a sixth rear lens L26R. In operation, the light from the object side is imaged on an image plane IMA2.

According to the foregoing, wherein: the sixth rear lens L26R is a meniscus lens, wherein the image side surface S215 is a convex surface; the eighth lens L28 is a biconcave lens, wherein the object side surface S218 is a concave surface; the ninth lens L29 is a biconvex lens, wherein the image side surface S221 is a convex surface; the tenth lens L210 is a biconvex lens, wherein the image side surface S223 is a convex surface; both of the object side surface S224 and image side surface S225 of the optical filter OF2 are plane surfaces; and both of the object side surface S226 and image side surface S227 of the cover glass CG2 are plane surfaces; with the above design of the lenses, stop ST2, and at least one of the conditions (1)-(7) satisfied, the wide-angle lens assembly 2 can have an effective increased field of view, an effective increased resolution, an effective corrected aberration, and an effective corrected chromatic aberration.

Table 4 shows the optical specification of the wide-angle lens assembly 2.

TABLE 4
Effective Focal Length = 7.07 mm F-number = 2.40
Total Lens Length = 54.98 mm Field of View = 131.58 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S21 | 64.69 | 1.34 | 1.44 | 95.10 | −28.84 | L21 |
| S22 | 10.50 | 4.89 | | | | |
| S23 | 97.04 | 1.03 | 1.46 | 90.27 | −20.41 | L22 |
| S24 | 8.49 | 6.51 | | | | |
| S25 | −13.16 | 1.01 | 1.50 | 81.61 | −20.48 | L23 |
| S26 | 46.53 | 0.67 | | | | |
| S27 | 21.51 | 2.87 | 2.00 | 25.46 | 11.85 | L24 |
| S28 | −25.05 | 1.22 | | | | |
| S29 | −14.87 | 2.68 | 1.67 | 32.21 | −9.26 | L25 |
| | | | | | | L25F |
| S210 | 11.61 | 2.59 | 1.91 | 35.25 | 9.15 | L25R |
| S211 | −26.82 | 1.47 | | | | |
| S212 | ∞ | 1.45 | | | | ST2 |
| S213 | 25.33 | 2.86 | 1.50 | 81.61 | 12.570 | L26 |
| | | | | | | L26F |
| S214 | −8.00 | 0.60 | 1.85 | 25.15 | −10.04 | L26R |
| S215 | −111.50 | 0.11 | | | | |
| S216 | 15.00 | 3.06 | 1.62 | 63.85 | 12.14 | L27 |
| S217 | −13.97 | 1.73 | | | | |
| S218 | −42.01 | 0.79 | 1.85 | 25.15 | −12.49 | L28 |
| S219 | 14.58 | 1.29 | | | | |
| S220 | 49.92 | 1.91 | 1.60 | 60.60 | 47.39 | L29 |
| S221 | −66.34 | 3.62 | | | | |
| S222 | 18.65 | 4.12 | 1.95 | 17.94 | 18.16 | L210 |
| S223 | −222.16 | 1.00 | | | | |
| S224 | ∞ | 0.84 | 1.55 | 70.00 | | OF2 |
| S225 | ∞ | 3.60 | | | | |
| S226 | ∞ | 0.50 | 1.52 | 64.17 | | CG2 |
| S227 | ∞ | 1.24 | | | | |

The definition of aspheric surface sag z of each aspheric surface in Table 4 is the same as that of in Table 1, and is not described here again.

In the second embodiment, the conic constant k and the aspheric coefficients A, B, C, D of each aspheric lens are shown in Table 5.

TABLE 5

| Surface | | | | | |
|---|---|---|---|---|---|
| Number | k | A | B | C | D |
| S216 | −8.38873 | 0.000224 | −1.8E−06 | 2.12E−08 | 2.26E−10 |
| S217 | −0.98687 | 0.000106 | 8.73E−07 | −1.1E−08 | 5.02E−10 |

Table 6 shows the parameters and condition values for conditions (1)-(7) in accordance with the second embodiment of the invention. It can be seen from Table 6 that the wide-angle lens assembly 2 of the second embodiment satisfies the conditions (1)-(7).

TABLE 6

| BFL | 7.18 mm | IH | 7.46 mm | | |
|---|---|---|---|---|---|
| TTL/BFL | 7.66 | TTL/IH | 7.37 | TTL/f | 7.77 |
| f1/f | −4.08 | f9/f | 6.70 | Vd10 | 17.94 |

| | |
|---|---|
| (Vd1 + Vd2 + Vd3)/Vd4 | 10.49 |

A detailed description of a wide-angle lens assembly in accordance with a third embodiment of the invention is as follows. The wide-angle lens assembly 3 includes a first lens L31, a second lens L32, a third lens L33, a fourth lens L34, a fifth lens L35, a stop ST3, a sixth lens L36, a seventh lens L37, an eighth lens L38, a ninth lens L39, a tenth lens L310, an optical filter OF3, and a cover glass CG3, all of which are arranged in order from an object side to an image side along an optical axis OA3. The fifth lens L35 is a cemented lens which is cemented by a fifth front lens L35F and a fifth rear lens L35R. The sixth lens L36 is a cemented lens which is cemented by a sixth front lens L36F and a sixth rear lens L36R. In operation, the light from the object side is imaged on an image plane IMA3.

According to the foregoing, wherein: the sixth rear lens L36R is a biconcave lens, wherein the image side surface S315 is a concave surface; the eighth lens L38 is a meniscus lens, wherein the object side surface S318 is a convex surface; the ninth lens L39 is a meniscus lens, wherein the image side surface S321 is a concave surface; the tenth lens L310 is a biconvex lens, wherein the image side surface S323 is a convex surface; both of the object side surface S324 and image side surface S325 of the optical filter OF3 are plane surfaces; and both of the object side surface S326 and image side surface S327 of the cover glass CG3 are plane surfaces; with the above design of the lenses, stop ST3, and at least one of the conditions (1)-(7) satisfied, the wide-angle lens assembly 3 can have an effective increased field of view, an effective increased resolution, an effective corrected aberration, and an effective corrected chromatic aberration.

Table 7 shows the optical specification of the wide-angle lens assembly 3.

TABLE 7
Effective Focal Length = 7.07 mm F-number = 2.40
Total Lens Length = 59.90 mm Field of View = 131.40 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S31 | 58.41 | 1.39 | 1.44 | 95.10 | −32.69 | L31 |
| S32 | 11.41 | 5.66 | | | | |
| S33 | 486611.15 | 0.98 | 1.46 | 90.27 | −19.37 | L32 |
| S34 | 8.86 | 6.64 | | | | |
| S35 | −15.34 | 1.01 | 1.50 | 81.61 | −25.17 | L33 |
| S36 | 70.10 | 1.23 | | | | |
| S37 | 24.82 | 3.11 | 2.00 | 25.46 | 13.48 | L34 |
| S38 | −28.13 | 1.65 | | | | |
| S39 | −16.52 | 3.62 | 1.67 | 32.21 | −10.15 | L35 |
| | | | | | | L35F |
| S310 | 12.78 | 2.92 | 1.91 | 35.25 | 9.85 | L35R |
| S311 | −27.27 | 1.46 | | | | |
| S312 | ∞ | 1.74 | | | | ST3 |
| S313 | 29.38 | 3.01 | 1.50 | 81.61 | 13.76 | L36 |
| | | | | | | L36F |
| S314 | −8.63 | 0.64 | 1.85 | 25.15 | −9.55 | L36R |
| S315 | 177.73 | 0.10 | | | | |
| S316 | 15.93 | 3.10 | 1.62 | 63.85 | 13.30 | L37 |
| S317 | −15.87 | 2.41 | | | | |
| S318 | 408.08 | 0.99 | 1.85 | 25.15 | −16.68 | L38 |
| S319 | 13.85 | 1.27 | | | | |
| S320 | 29.96 | 2.05 | 1.60 | 60.60 | 55.02 | L39 |
| S321 | 292.48 | 3.33 | | | | |
| S322 | 18.13 | 4.33 | 1.95 | 17.94 | 18.43 | L310 |
| S323 | −532.42 | 1.00 | | | | |
| S324 | ∞ | 0.84 | 1.55 | 70.00 | | OF3 |
| S325 | ∞ | 3.30 | | | | |
| S326 | ∞ | 0.50 | 1.52 | 64.17 | | CG3 |
| S327 | ∞ | 1.62 | | | | |

The definition of aspheric surface sag z of each aspheric surface in Table 7 is the same as that of in Table 1, and is not described here again.

In the third embodiment, the conic constant k and the aspheric coefficients A, B, C, D of each aspheric lens are shown in Table 8.

TABLE 8

| Surface | | | | | |
|---|---|---|---|---|---|
| Number | k | A | B | C | D |
| S316 | −9.85752 | 0.00022 | −2.5E−06 | 4.08E−08 | −1.7E−10 |
| S317 | −0.71851 | 6.76E−05 | 6.86E−07 | 3.68E−09 | 1.26E−10 |

Table 9 shows the parameters and condition values for conditions (1)-(7) in accordance with the third embodiment of the invention. It can be seen from Table 9 that the wide-angle lens assembly 3 of the third embodiment satisfies the conditions (1)-(7).

TABLE 9

| BFL | 7.26 mm | IH | 7.46 mm | | |
|---|---|---|---|---|---|
| TTL/BFL | 8.25 | TTL/IH | 8.03 | TTL/f | 8.48 |
| f1/f | −4.63 | f9/f | 7.79 | Vd10 | 17.94 |

| | |
|---|---|
| (Vd1 + Vd2 + Vd3)/Vd4 | 10.49 |

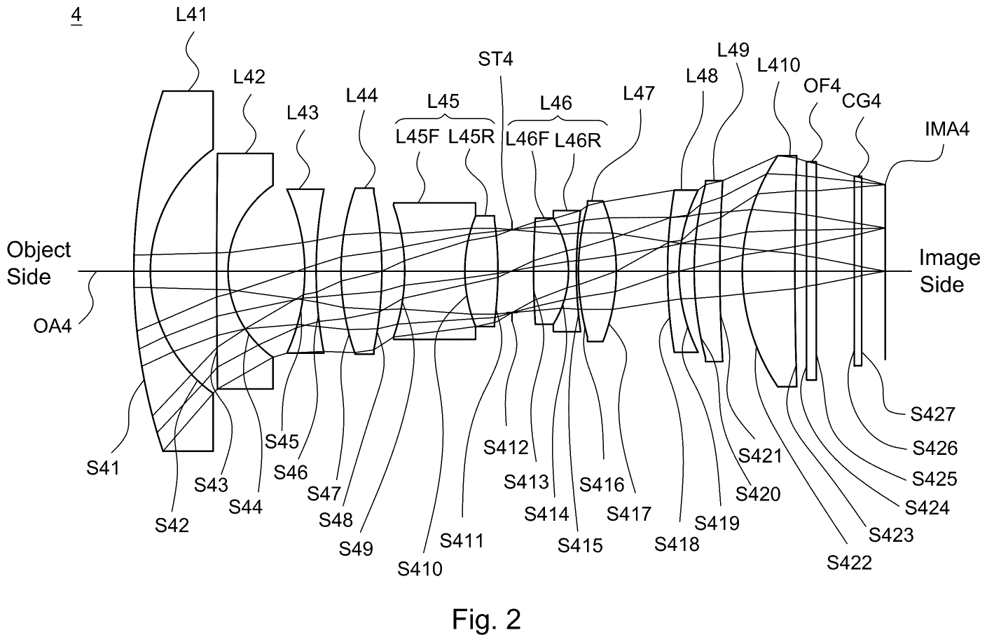

A detailed description of a wide-angle lens assembly in accordance with a fourth embodiment of the invention is as follows. Referring to FIG. 2, the wide-angle lens assembly 4 includes a first lens L41, a second lens L42, a third lens L43, a fourth lens LA4, a fifth lens L45, a stop ST4, a sixth lens L46, a seventh lens L47, an eighth lens L48, a ninth lens L49, a tenth lens LA10, an optical filter OF4, and a cover glass CG4, all of which are arranged in order from an object side to an image side along an optical axis OA4. The fifth lens L45 is a cemented lens which is cemented by a fifth front lens LA5F and a fifth rear lens LA5R. The sixth lens L46 is a cemented lens which is cemented by a sixth front lens L46F and a sixth rear lens L46R. In operation, the light from the object side is imaged on an image plane IMA4.

According to the foregoing, wherein: the sixth rear lens LA6R is a biconcave lens, wherein the image side surface S415 is a concave surface; the eighth lens LA8 is a meniscus lens, wherein the object side surface S418 is a convex surface; the ninth lens L49 is a meniscus lens, wherein the image side surface S421 is a concave surface; the tenth lens L410 is a meniscus lens, wherein the image side surface S423 is a concave surface; both of the object side surface S424 and image side surface S425 of the optical filter OF4 are plane surfaces; and both of the object side surface S426 and image side surface S427 of the cover glass CG4 are plane surfaces; with the above design of the lenses, stop ST4, and at least one of the conditions (1)-(7) satisfied, the wide-angle lens assembly 4 can have an effective increased field of view, an effective increased resolution, an effective corrected aberration, and an effective corrected chromatic aberration.

Table 10 shows the optical specification of the wide-angle lens assembly 4 in FIG. 2.

TABLE 10
Effective Focal Length = 7.07 mm F-number = 2.40
Total Lens Length = 64.99 mm Field of View = 131.30 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S41 | 49.45 | 1.31 | 1.44 | 95.10 | −39.11 | L41 |
| S42 | 12.62 | 5.87 | | | | |
| S43 | 3960.25 | 0.94 | 1.46 | 90.27 | −20.05 | L42 |
| S44 | 9.15 | 6.64 | | | | |
| S45 | −17.91 | 0.96 | 1.50 | 81.61 | −23.92 | L43 |
| S46 | 36.25 | 2.23 | | | | |
| S47 | 23.75 | 3.50 | 2.00 | 25.46 | 14.16 | L44 |
| S48 | −33.09 | 1.97 | | | | |
| S49 | −18.75 | 5.19 | 1.67 | 32.21 | −10.39 | L45 |
| | | | | | | L45F |
| S410 | 12.50 | 2.93 | 1.91 | 35.25 | 9.93 | L45R |
| S411 | −29.64 | 1.14 | | | | |
| S412 | ∞ | 1.91 | | | | ST4 |
| S413 | 44.55 | 3.06 | 1.50 | 81.61 | 14.68 | L46 |
| | | | | | | L46F |
| S414 | −8.55 | 0.63 | 1.85 | 25.15 | −8.30 | L46R |
| S415 | 45.03 | 0.10 | | | | |
| S416 | 17.07 | 3.36 | 1.62 | 63.85 | 13.80 | L47 |
| S417 | −15.90 | 4.47 | | | | |
| S418 | 49.01 | 0.91 | 1.85 | 25.15 | −26.41 | L48 |
| S419 | 15.39 | 1.35 | | | | |
| S420 | 28.67 | 2.27 | 1.60 | 60.60 | 58.70 | L49 |
| S421 | 144.58 | 1.96 | | | | |
| S422 | 17.94 | 4.55 | 1.95 | 17.94 | 19.21 | L410 |
| S423 | 700.35 | 1.00 | | | | |
| S424 | ∞ | 0.84 | 1.55 | 70.00 | | OF4 |
| S425 | ∞ | 3.30 | | | | |
| S426 | ∞ | 0.50 | 1.52 | 64.17 | | CG4 |
| S427 | ∞ | 2.11 | | | | |

The definition of aspheric surface sag z of each aspheric surface in Table 10 is the same as that of in Table 1, and is not described here again.

In the fourth embodiment, the conic constant k and the aspheric coefficients A, B, C, D of each aspheric lens are shown in Table 11.

TABLE 11

| Surface | | | | | |
|---|---|---|---|---|---|
| Number | k | A | B | C | D |
| S416 | −9.85752 | 0.00022 | −2.5E−06 | 4.08E−08 | −1.7E−10 |
| S417 | −0.71851 | 6.76E−05 | 6.86E−07 | 3.68E−09 | 1.26E−10 |

Table 12 shows the parameters and condition values for conditions (1)-(7) in accordance with the fourth embodiment of the invention. It can be seen from Table 12 that the wide-angle lens assembly 4 of the fourth embodiment satisfies the conditions (1)-(7).

TABLE 12

| BFL | 7.75 mm | IH | 7.46 mm | | |
|---|---|---|---|---|---|
| TTL/BFL | 8.39 | TTL/IH | 8.71 | TTL/f | 9.19 |
| f1/f | −5.53 | f9/f | 8.30 | Vd10 | 17.94 |

| | |
|---|---|
| (Vd1 + Vd2 + Vd3)/Vd4 | 10.49 |

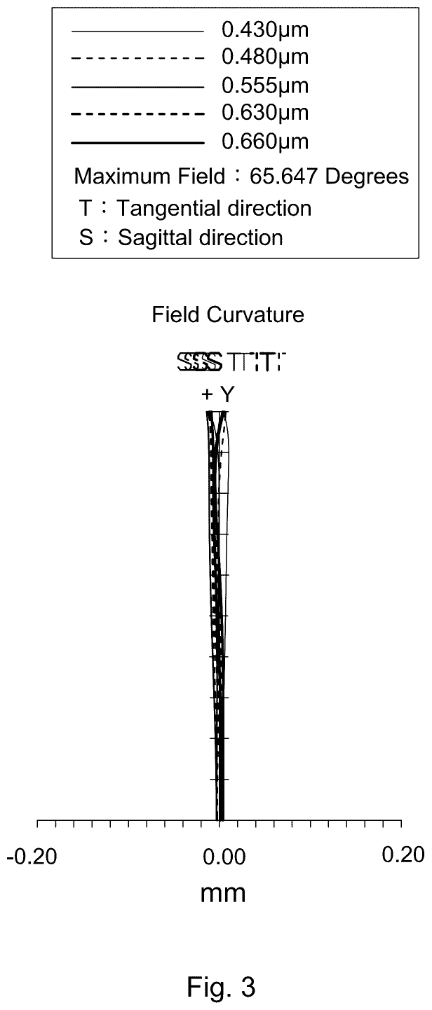

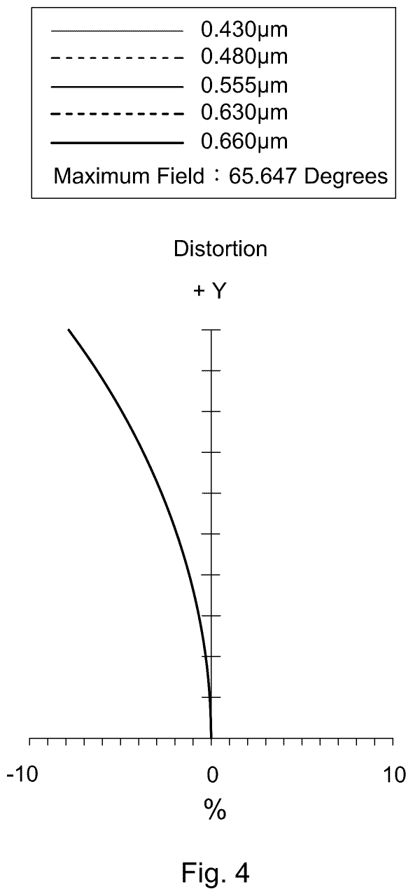

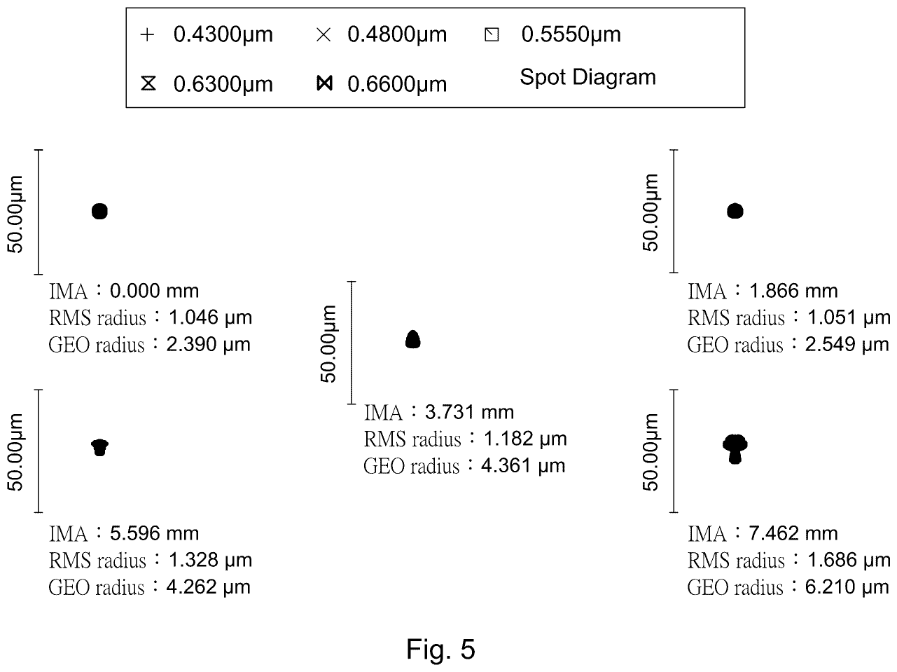

In addition, the wide-angle lens assembly 4 of the fourth embodiment can meet the requirements of optical performance as seen in FIGS. 3-5. It can be seen from FIG. 3 that the field curvature of tangential direction and sagittal direction in the wide-angle lens assembly 4 of the fourth embodiment ranges from −0.01 mm to 0.01 mm. It can be seen from FIG. 4 that the distortion in the wide-angle lens assembly 4 of the fourth embodiment ranges from −8% to 0%. It can be seen from FIG. 5 that the root mean square spot radius is equal to 1.046 μm and geometrical spot radius is equal to 2.390 μm as image height is equal to 0.000 mm, the root mean square spot radius is equal to 1.051 μm and geometrical spot radius is equal to 2.549 μm as image height is equal to 1.866 mm, the root mean square spot radius is equal to 1.182 μm and geometrical spot radius is equal to 4.361 μm as image height is equal to 3.731 mm, the root mean square spot radius is equal to 1.328 μm and geometrical spot radius is equal to 4.262 μm as image height is equal to 5.596 mm, and the root mean square spot radius is equal to 1.686 μm and geometrical spot radius is equal to 6.210 μm as image height is equal to 7.462 mm for the wide-angle lens assembly 4 of the fourth embodiment. It is obvious that the field curvature and the distortion of the wide-angle lens assembly 4 of the fourth embodiment can be corrected effectively. Therefore, the wide-angle lens assembly 4 of the fourth embodiment is capable of good optical performance.

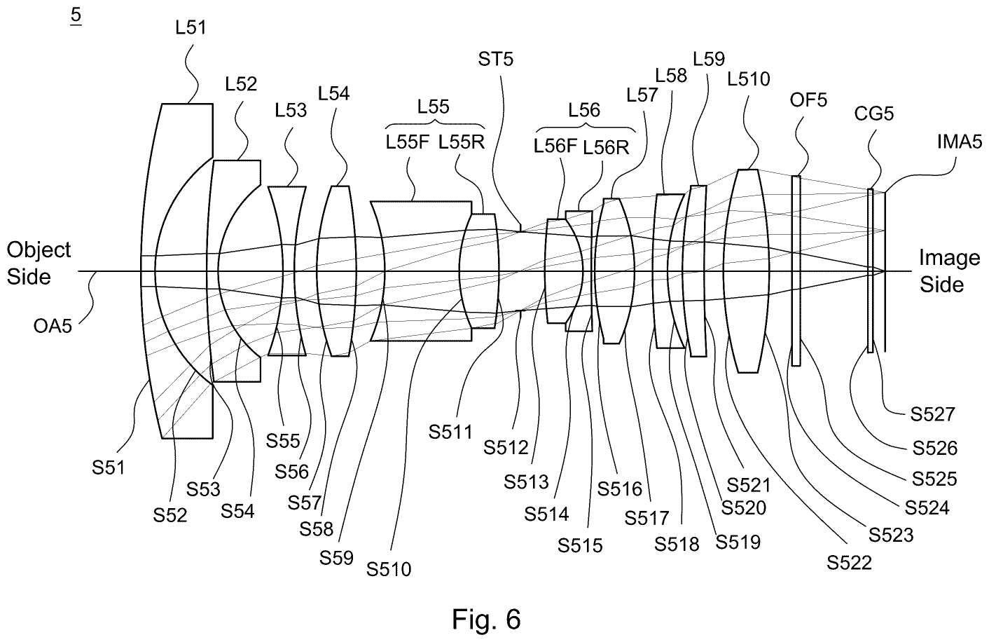

A detailed description of a wide-angle lens assembly in accordance with a fifth embodiment of the invention is as follows. Referring to FIG. 6, the wide-angle lens assembly 5 includes a first lens L51, a second lens L52, a third lens L53, a fourth lens L54, a fifth lens L55, a stop ST5, a sixth lens L56, a seventh lens L57, an eighth lens L58, a ninth lens L59, a tenth lens L510, an optical filter OF5, and a cover glass CG5, all of which are arranged in order from an object side to an image side along an optical axis OA5. The fifth lens L55 is a cemented lens which is cemented by a fifth front lens L55F and a fifth rear lens L55R. The sixth lens L56 is a cemented lens which is cemented by a sixth front lens L56F and a sixth rear lens L56R. In operation, the light from the object side is imaged on an image plane IMA5.

According to the foregoing, wherein: the sixth rear lens L56R is a biconcave lens, wherein the image side surface S515 is a concave surface; the eighth lens L58 is a meniscus lens, wherein the object side surface S518 is a convex surface; the ninth lens L59 is a meniscus lens, wherein the image side surface S521 is a concave surface; the tenth lens L510 is a biconvex lens, wherein the image side surface S523 is a convex surface; both of the object side surface S524 and image side surface S525 of the optical filter OF5 are plane surfaces; and both of the object side surface S526 and image side surface S527 of the cover glass CG5 are plane surfaces; with the above design of the lenses, stop ST5, and at least one of the conditions (1)-(7) satisfied, the wide-angle lens assembly 5 can have an effective increased field of view, an effective increased resolution, an effective corrected aberration, and an effective corrected chromatic aberration.

Table 13 shows the optical specification of the wide-angle lens assembly 5 in FIG. 6.

TABLE 13
Effective Focal Length = 7.04 mm F-number = 2.40
Total Lens Length = 70.00 mm Field of View = 131.94 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S51 | 69.16 | 1.24 | 1.44 | 95.10 | −37.97 | L51 |
| S52 | 13.33 | 4.99 | | | | |
| S53 | 93.15 | 1.01 | 1.59 | 68.62 | −19.60 | L52 |
| S54 | 10.31 | 6.04 | | | | |
| S55 | −22.16 | 1.08 | 1.50 | 81.61 | −25.47 | L53 |
| S56 | 30.17 | 2.08 | | | | |
| S57 | 23.18 | 3.82 | 2.00 | 25.46 | 14.71 | L54 |
| S58 | −37.75 | 2.62 | | | | |
| S59 | −16.74 | 7.01 | 1.65 | 33.85 | −10.42 | L55 |
| | | | | | | L55F |
| S510 | 13.30 | 3.72 | 1.90 | 37.37 | 10.51 | L55R |
| S511 | −28.92 | 2.00 | | | | |
| S512 | ∞ | 2.26 | | | | ST5 |
| S513 | 35.61 | 3.63 | 1.50 | 81.61 | 13.58 | L56 |
| | | | | | | L56F |
| S514 | −8.07 | 0.70 | 1.85 | 25.15 | −8.56 | L56R |
| S515 | 88.02 | 0.37 | | | | |
| S516 | 21.32 | 3.79 | 1.62 | 63.85 | 15.23 | L57 |
| S517 | −15.83 | 1.69 | | | | |
| S518 | 58.40 | 1.40 | 1.85 | 25.15 | −27.43 | L58 |
| S519 | 16.63 | 1.35 | | | | |
| S520 | 32.87 | 2.12 | 1.44 | 95.10 | 99.34 | L59 |
| S521 | 131.86 | 1.83 | | | | |
| S522 | 33.23 | 4.40 | 1.95 | 17.94 | 19.22 | L510 |
| S523 | −38.37 | 2.00 | | | | |
| S524 | ∞ | 0.84 | 1.55 | 70.00 | | OF5 |
| S525 | ∞ | 6.30 | | | | |
| S526 | ∞ | 0.50 | 1.52 | 64.17 | | CG5 |
| S527 | ∞ | 1.21 | | | | |

The definition of aspheric surface sag z of each aspheric surface in Table 13 is the same as that of in Table 1, and is not described here again.

In the fifth embodiment, the conic constant k and the aspheric coefficients A, B, C, D of each aspheric lens are shown in Table 14.

TABLE 14

| Surface | | | | | |
|---|---|---|---|---|---|
| Number | k | A | B | C | D |
| S516 | −12.0038 | 5.41E−05 | −3.2E−07 | 2.88E−10 | −9.5E−12 |
| S517 | −0.03648 | 2.8E−06 | 1.13E−07 | 3.89E−09 | −6.9E−11 |

Table 15 shows the parameters and condition values for conditions (1)-(7) in accordance with the fifth embodiment of the invention. It can be seen from Table 15 that the wide-angle lens assembly 5 of the fifth embodiment satisfies the conditions (1)-(7).

TABLE 15

| BFL | 10.85 mm | IH | 7.46 mm | | |
|---|---|---|---|---|---|
| TTL/BFL | 6.45 | TTL/IH | 9.38 | TTL/f | 9.94 |
| f1/f | −5.39 | f9/f | 14.11 | Vd10 | 17.94 |

| | |
|---|---|
| (Vd1 + Vd2 + Vd3)/Vd4 | 9.64 |

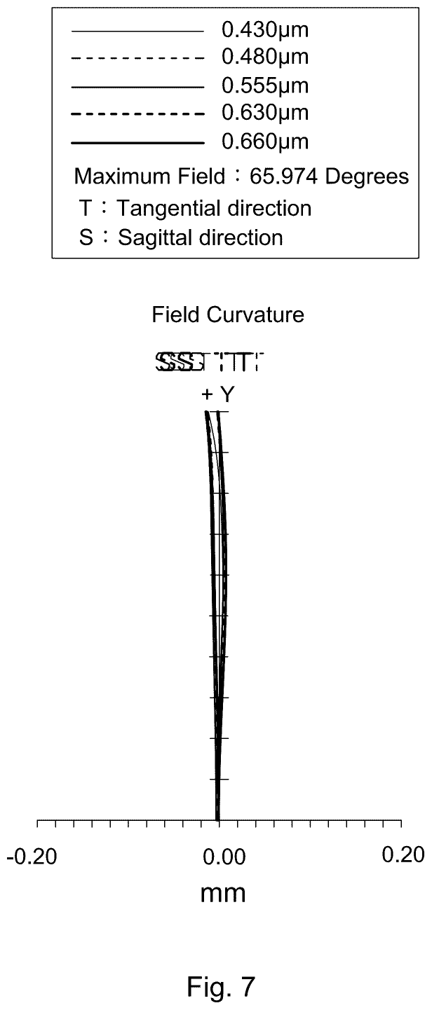

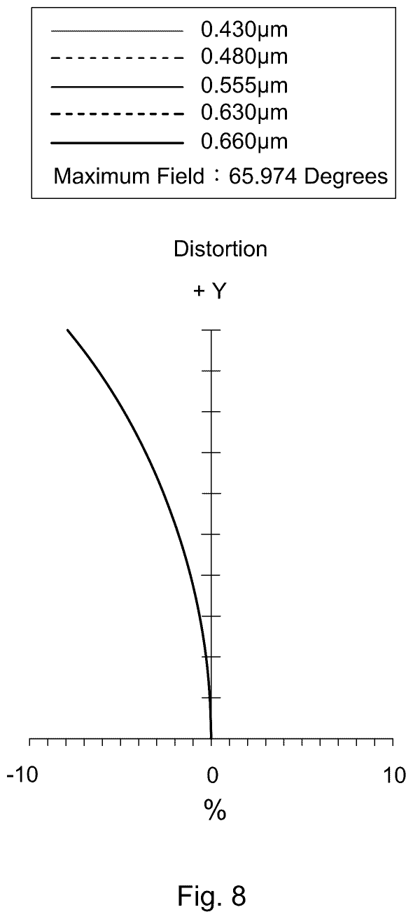

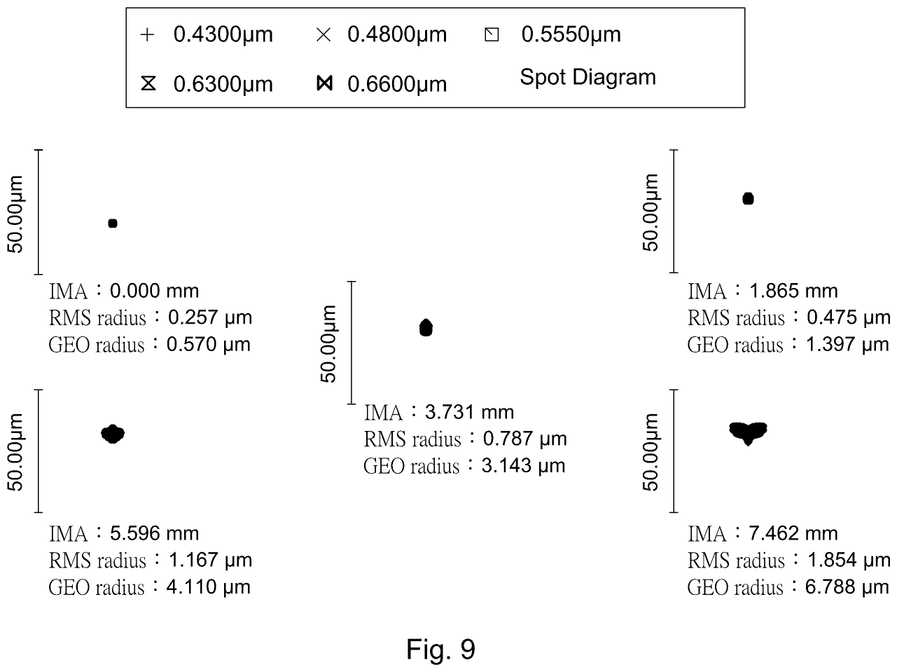

In addition, the wide-angle lens assembly 5 of the fifth embodiment can meet the requirements of optical performance as seen in FIGS. 7-9. It can be seen from FIG. 7 that the field curvature of tangential direction and sagittal direction in the wide-angle lens assembly 5 of the fifth embodiment ranges from −0.01 mm to 0.01 mm. It can be seen from FIG. 8 that the distortion in the wide-angle lens assembly 5 of the fifth embodiment ranges from −8% to 0%. It can be seen from FIG. 9 that the root mean square spot radius is equal to 0.257 μm and geometrical spot radius is equal to 0.570 μm as image height is equal to 0.000 mm, the root mean square spot radius is equal to 0.475 μm and geometrical spot radius is equal to 1.397 μm as image height is equal to 1.865 mm, the root mean square spot radius is equal to 0.787 μm and geometrical spot radius is equal to 3.143 μm as image height is equal to 3.731 mm, the root mean square spot radius is equal to 1.167 μm and geometrical spot radius is equal to 4.110 μm as image height is equal to 5.596 mm, and the root mean square spot radius is equal to 1.854 μm and geometrical spot radius is equal to 6.788 μm as image height is equal to 7.462 mm for the wide-angle lens assembly 5 of the fifth embodiment. It is obvious that the field curvature and the distortion of the wide-angle lens assembly 5 of the fifth embodiment can be corrected effectively. Therefore, the wide-angle lens assembly 5 of the fifth embodiment is capable of good optical performance.

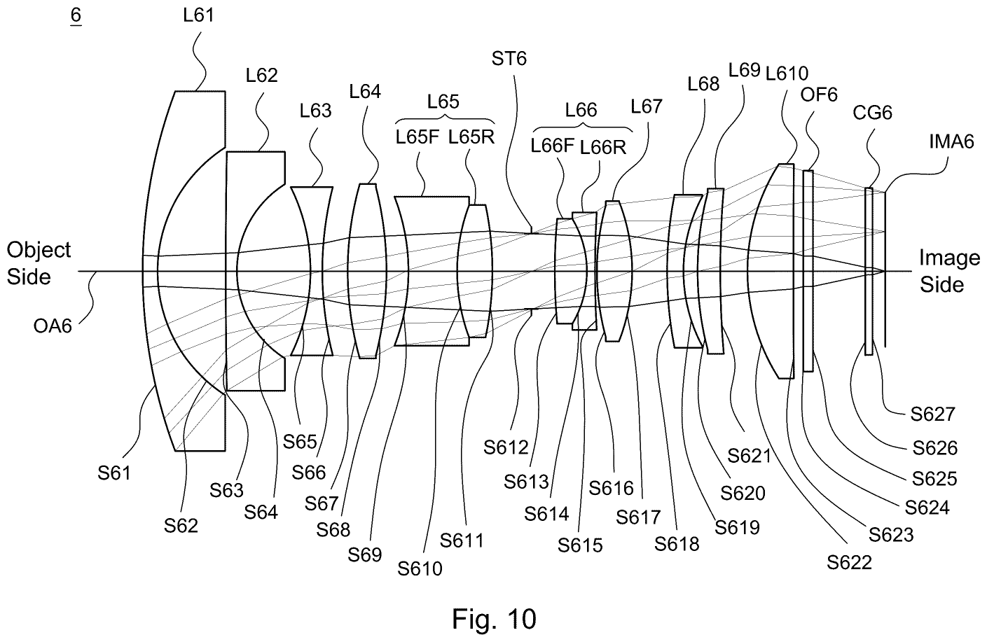

A detailed description of a wide-angle lens assembly in accordance with a sixth embodiment of the invention is as follows. Referring to FIG. 10, the wide-angle lens assembly 6 includes a first lens L61, a second lens L62, a third lens L63, a fourth lens L64, a fifth lens L65, a stop ST6, a sixth lens L66, a seventh lens L67, an eighth lens L68, a ninth lens L69, a tenth lens L610, an optical filter OF6, and a cover glass CG6, all of which are arranged in order from an object side to an image side along an optical axis OA6. The fifth lens L65 is a cemented lens which is cemented by a fifth front lens L65F and a fifth rear lens L65R. The sixth lens L66 is a cemented lens which is cemented by a sixth front lens L66F and a sixth rear lens L66R. In operation, the light from the object side is imaged on an image plane IMA6.

According to the foregoing, wherein: the sixth rear lens L66R is a biconcave lens, wherein the image side surface S615 is a concave surface; the eighth lens L68 is a meniscus lens, wherein the object side surface S618 is a convex surface; the ninth lens L69 is a meniscus lens, wherein the image side surface S621 is a concave surface; the tenth lens L610 is a meniscus lens, wherein the image side surface S623 is a concave surface; both of the object side surface S624 and image side surface S625 of the optical filter OF6 are plane surfaces; and both of the object side surface S626 and image side surface S627 of the cover glass CG6 are plane surfaces; with the above design of the lenses, stop ST6, and at least one of the conditions (1)-(7) satisfied, the wide-angle lens assembly 6 can have an effective increased field of view, an effective increased resolution, an effective corrected aberration, and an effective corrected chromatic aberration.

Table 16 shows the optical specification of the wide-angle lens assembly 6 in FIG. 10.

TABLE 16
Effective Focal Length = 7.05 mm F-number = 2.40
Total Lens Length = 70.02 mm Field of View = 131.80 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S61 | 50.13 | 1.28 | 1.44 | 95.10 | −43.41 | L61 |
| S62 | 13.67 | 6.47 | | | | |
| S63 | 762.76 | 1.07 | 1.46 | 90.27 | −21.40 | L62 |
| S64 | 9.66 | 6.99 | | | | |
| S65 | −18.18 | 1.07 | 1.50 | 81.61 | −23.45 | L63 |
| S66 | 33.30 | 2.38 | | | | |
| S67 | 29.66 | 3.83 | 2.00 | 25.46 | 15.36 | L64 |
| S68 | −30.28 | 1.99 | | | | |
| S69 | −19.05 | 4.51 | 1.67 | 32.21 | −12.47 | L65 |
| | | | | | | L65F |
| S610 | 16.58 | 3.41 | 1.90 | 37.37 | 12.22 | L65R |
| S611 | −29.95 | 3.71 | | | | |
| S612 | ∞ | 2.19 | | | | ST6 |
| S613 | 46.03 | 3.05 | 1.50 | 81.61 | 16.13 | L66 |
| | | | | | | L66F |
| S614 | −9.52 | 0.64 | 1.85 | 25.15 | −9.69 | L66R |
| S615 | 69.10 | 0.09 | | | | |
| S616 | 17.58 | 3.50 | 1.62 | 63.85 | 14.56 | L67 |
| S617 | −17.20 | 3.34 | | | | |
| S618 | 36.08 | 1.42 | 1.85 | 25.15 | −28.94 | L68 |
| S619 | 14.47 | 1.47 | | | | |
| S620 | 29.40 | 2.06 | 1.68 | 55.52 | 68.79 | L69 |
| S621 | 76.84 | 2.67 | | | | |
| S622 | 18.59 | 4.32 | 1.95 | 17.94 | 19.98 | L610 |
| S623 | 638.53 | 1.00 | | | | |
| S624 | ∞ | 0.84 | 1.55 | 70.00 | | OF6 |
| S625 | ∞ | 5.03 | | | | |
| S626 | ∞ | 0.50 | 1.52 | 64.17 | | CG6 |
| S627 | ∞ | 1.21 | | | | |

The definition of aspheric surface sag z of each aspheric surface in Table 16 is the same as that of in Table 1, and is not described here again.

In the sixth embodiment, the conic constant k and the aspheric coefficients A, B, C, D of each aspheric lens are shown in Table 17.

TABLE 17

| Surface | | | | | |
|---|---|---|---|---|---|
| Number | k | A | B | C | D |
| S616 | −10.7981 | 0.00016 | −2.5E−06 | 2.78E−08 | −1.7E−10 |
| S617 | 0.527762 | 2.7E−05 | 3.31E−07 | −2.8E−09 | −1.2E−13 |

Table 18 shows the parameters and condition values for conditions (1)-(7) in accordance with the sixth embodiment of the invention. It can be seen from Table 18 that the wide-angle lens assembly 6 of the sixth embodiment satisfies the conditions (1)-(7).

TABLE 18

| BFL | 8.58 mm | IH | 7.46 mm | | |
|---|---|---|---|---|---|
| TTL/BFL | 8.16 | TTL/IH | 9.38 | TTL/f | 9.94 |
| f1/f | −6.16 | f9/f | 9.76 | Vd10 | 17.94 |

| | |
|---|---|
| (Vd1 + Vd2 + Vd3)/Vd4 | 10.49 |

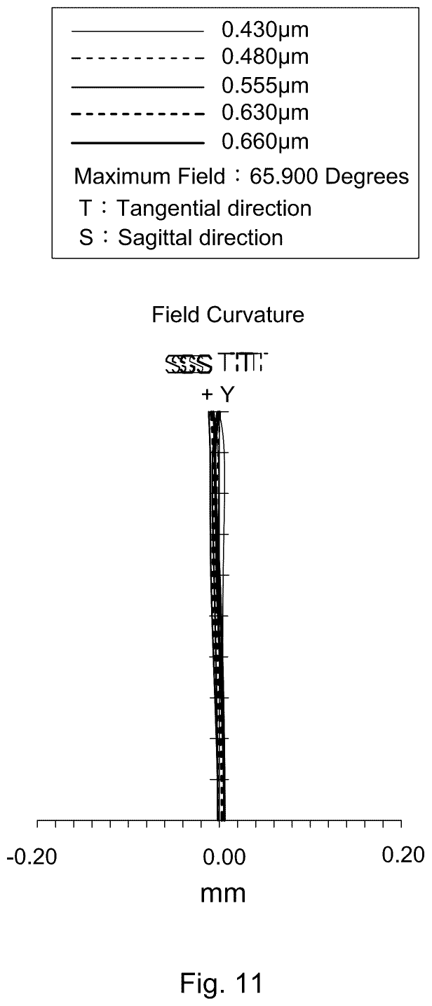

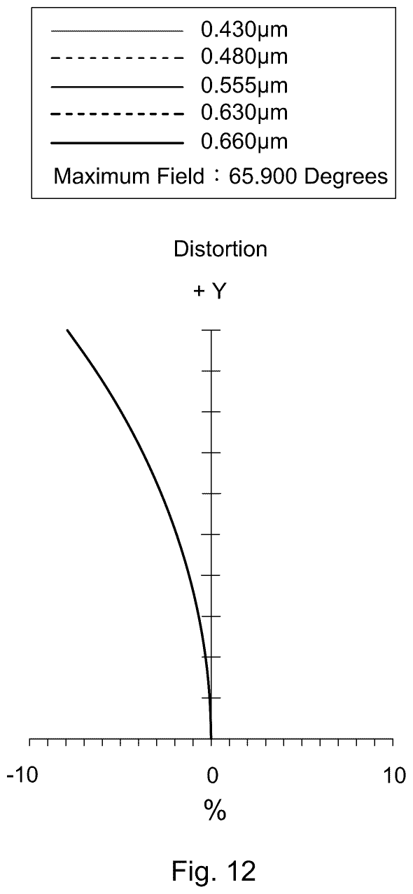

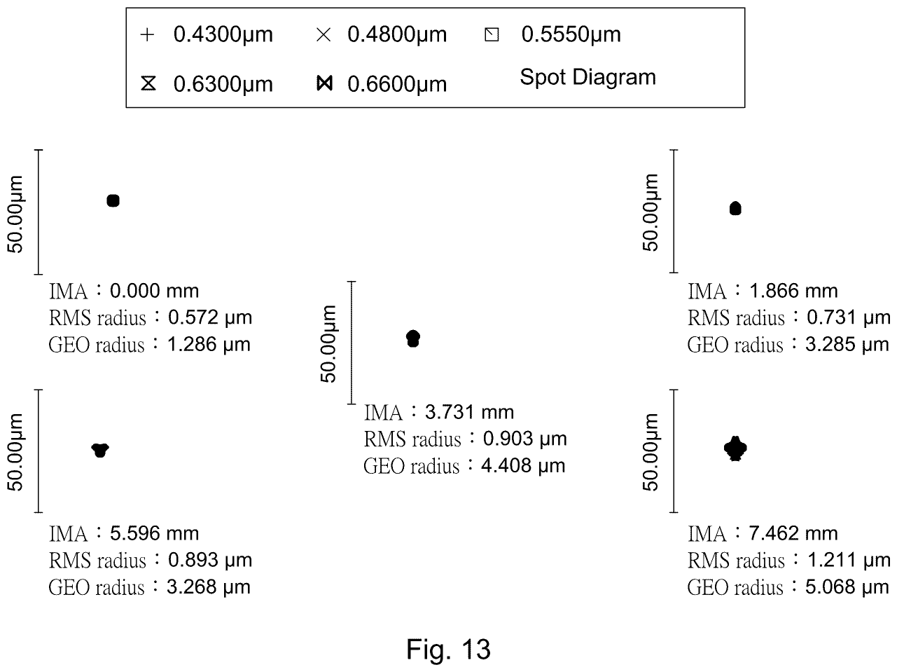

In addition, the wide-angle lens assembly 6 of the sixth embodiment can meet the requirements of optical performance as seen in FIGS. 11-13. It can be seen from FIG. 11 that the field curvature of tangential direction and sagittal direction in the wide-angle lens assembly 6 of the sixth embodiment ranges from −0.01 mm to 0.01 mm. It can be seen from FIG. 12 that the distortion in the wide-angle lens assembly 6 of the sixth embodiment ranges from −8% to 0%. It can be seen from FIG. 13 that the root mean square spot radius is equal to 0.572 μm and geometrical spot radius is equal to 1.286 μm as image height is equal to 0.000 mm, the root mean square spot radius is equal to 0.731 μm and geometrical spot radius is equal to 3.285 μm as image height is equal to 1.866 mm, the root mean square spot radius is equal to 0.903 μm and geometrical spot radius is equal to 4.408 μm as image height is equal to 3.731 mm, the root mean square spot radius is equal to 0.893 μm and geometrical spot radius is equal to 3.268 μm as image height is equal to 5.596 mm, and the root mean square spot radius is equal to 1.211 μm and geometrical spot radius is equal to 5.068 μm as image height is equal to 7.462 mm for the wide-angle lens assembly 6 of the sixth embodiment. It is obvious that the field curvature and the distortion of the wide-angle lens assembly 6 of the sixth embodiment can be corrected effectively. Therefore, the wide-angle lens assembly 6 of the sixth embodiment is capable of good optical performance.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wide-angle lens assembly comprising:
a first lens which is a meniscus lens with negative refractive power;
a second lens which is with refractive power;
a third lens which is with negative refractive power;
a fourth lens which is with positive refractive power;
a fifth lens which is a meniscus lens with refractive power and comprises a concave surface facing an object side and a convex surface facing an image side;
a sixth lens which is with refractive power and comprises a convex surface facing the object side;
a seventh lens which is with positive refractive power;
an eighth lens which is with refractive power and comprises a concave surface facing the image side;
a ninth lens which is with positive refractive power; and
a tenth lens which is with positive refractive power and comprises a convex surface facing the object side;
wherein the first lens, the second lens, the third lens, the fourth lens, the fifth lens, the sixth lens, the seventh lens, the eighth lens, the ninth lens, and the tenth lens are arranged in order from the object side to the image side along an optical axis.

2. The wide-angle lens assembly as claimed in claim 1, wherein:
the fifth lens is with positive refractive power and comprises a fifth front lens and a fifth rear lens, wherein the fifth front lens is a biconcave lens with negative refractive power and comprises a concave surface facing the object side and another concave surface facing the image side and the fifth rear lens is a biconvex lens with positive refractive power and comprises a convex surface facing the object side and another convex surface facing the image side;
the fifth front lens and the fifth rear lens are spaced apart without air gaps formed therebetween;
the sixth lens is with negative refractive power and comprises a sixth front lens and a sixth rear lens, wherein the sixth front lens is a biconvex lens with positive refractive power and comprises a convex surface facing the object side and another convex surface facing the image side and the sixth rear lens is with negative refractive power and comprises a concave surface facing the object side; and
the sixth front lens and the sixth rear lens are spaced apart without air gaps formed therebetween.

3. The wide-angle lens assembly as claimed in claim 2, wherein:
the sixth rear lens is a meniscus lens and further comprises a convex surface facing the image side;
the eighth lens is a biconcave lens with negative refractive power and further comprises another concave surface facing the object side;
the ninth lens comprises a convex surface facing the image side; and
the tenth lens is a biconvex lens and further comprises another convex surface facing the image side.

4. The wide-angle lens assembly as claimed in claim 3, wherein the wide-angle lens assembly satisfies at least one of following conditions:
$$6 \leq TTL / BFL \leq 9 ;$$
$$6 \leq TTL / IH \leq 10 ;$$
$$6.5 \leq TTL / f \leq 10.5 ;$$
$$- 7 \leq f 1 / f \leq - 3 ;$$
$$6 \leq f 9 / f \leq 15 ;$$
$$Vd 10 \leq 21 ;$$
$$9 \leq ( Vd 1 + Vd 2 + Vd 3 ) / Vd 4 \leq 11 ;$$
wherein TTL is an interval from an object side surface of the first lens to an image plane along the optical axis, BFL is an interval from an image side surface of the tenth lens to the image plane along the optical axis, IH is an image height of the wide-angle lens assembly, f is an effective focal length of the wide-angle lens assembly, f1 is an effective focal length of the first lens, f9 is an effective focal length of the ninth lens, Vd1 is an Abbe number of the first lens, Vd2 is an Abbe number of the second lens, Vd3 is an Abbe number of the third lens, Vd4 is an Abbe number of the fourth lens, and Vd10 is an Abbe number of the tenth lens.

5. The wide-angle lens assembly as claimed in claim 2, wherein:
the sixth rear lens is a biconcave lens and further comprises another concave surface facing the image side;
the eighth lens is a meniscus lens and further comprises a convex surface facing the object side;
the ninth lens comprises a concave surface facing the image side; and
the tenth lens is a biconvex lens and further comprises another convex surface facing the image side.

6. The wide-angle lens assembly as claimed in claim 5, wherein the wide-angle lens assembly satisfies at least one of following conditions:
$$6 \leq TTL / BFL \leq 9 ;$$
$$6 \leq TTL / IH \leq 10 ;$$
$$6.5 \leq TTL / f \leq 10.5 ;$$
$$- 7 \leq f 1 / f \leq - 3 ;$$
$$6 \leq f 9 / f \leq 15 ;$$
$$Vd 10 \leq 21 ;$$
$$9 \leq ( Vd 1 + Vd 2 + Vd 3 ) / Vd 4 \leq 11 ;$$
wherein TTL is an interval from an object side surface of the first lens to an image plane along the optical axis, BFL is an interval from an image side surface of the tenth lens to the image plane along the optical axis, IH is an image height of the wide-angle lens assembly, f is an effective focal length of the wide-angle lens assembly, f1 is an effective focal length of the first lens, f9 is an effective focal length of the ninth lens, Vd1 is an Abbe number of the first lens, Vd2 is an Abbe number of the second lens, Vd3 is an Abbe number of the third lens, Vd4 is an Abbe number of the fourth lens, and Vd10 is an Abbe number of the tenth lens.

7. The wide-angle lens assembly as claimed in claim 2, wherein:
the sixth rear lens is a biconcave lens and further comprises another concave surface facing the image side;
the eighth lens is a meniscus lens and further comprises a convex surface facing the object side;
the ninth lens comprises a concave surface facing the image side; and
the tenth lens is a meniscus lens and further comprises a concave surface facing the image side.

8. The wide-angle lens assembly as claimed in claim 7, wherein the wide-angle lens assembly satisfies at least one of following conditions:
$$6 \leq TTL / BFL \leq 9 ;$$
$$6 \leq TTL / IH \leq 10 ;$$
$$6.5 \leq TTL / f \leq 10.5 ;$$
$$- 7 \leq f 1 / f \leq - 3 ;$$
$$6 \leq f 9 / f \leq 15 ;$$
$$Vd 10 \leq 21 ;$$
$$9 \leq ( Vd 1 + Vd 2 + Vd 3 ) / Vd 4 \leq 11 ;$$
wherein TTL is an interval from an object side surface of the first lens to an image plane along the optical axis, BFL is an interval from an image side surface of the tenth lens to the image plane along the optical axis, IH is an image height of the wide-angle lens assembly, f is an effective focal length of the wide-angle lens assembly, f1 is an effective focal length of the first lens, f9 is an effective focal length of the ninth lens, Vd1 is an Abbe number of the first lens, Vd2 is an Abbe number of the second lens, Vd3 is an Abbe number of the third lens, Vd4 is an Abbe number of the fourth lens, and Vd10 is an Abbe number of the tenth lens.

9. The wide-angle lens assembly as claimed in claim 1, wherein:
the first lens comprises a convex surface facing the object side and a concave surface facing the image side;
the second lens is a meniscus lens with negative refractive power and comprises a convex surface facing the object side and a concave surface facing the image side;
the third lens is a biconcave lens and comprises a concave surface facing the object side and another concave surface facing the image side;
the fourth lens is a biconvex lens and comprises a convex surface facing the object side and another convex surface facing the image side;
the seventh lens is a biconvex lens and comprises a convex surface facing the object side and another convex surface facing the image side;
the eighth lens is with negative refractive power; and
the ninth lens comprises a convex surface facing the object side.

10. The wide-angle lens assembly as claimed in claim 9, wherein the wide-angle lens assembly satisfies at least one of following conditions:
$$6 \leq TTL / BFL \leq 9 ;$$
$$6 \leq TTL / IH \leq 10 ;$$
$$6.5 \leq TTL / f \leq 10.5 ;$$
$$- 7 \leq f 1 / f \leq - 3 ;$$
$$6 \leq f 9 / f \leq 15 ;$$
$$Vd 10 \leq 21 ;$$
$$9 \leq ( Vd 1 + Vd 2 + Vd 3 ) / Vd 4 \leq 11 ;$$
wherein TTL is an interval from an object side surface of the first lens to an image plane along the optical axis, BFL is an interval from an image side surface of the tenth lens to the image plane along the optical axis, IH is an image height of the wide-angle lens assembly, f is an effective focal length of the wide-angle lens assembly, f1 is an effective focal length of the first lens, f9 is an effective focal length of the ninth lens, Vd1 is an Abbe number of the first lens, Vd2 is an Abbe number of the second lens, Vd3 is an Abbe number of the third lens, Vd4 is an Abbe number of the fourth lens, and Vd10 is an Abbe number of the tenth lens.

11. A wide-angle lens assembly comprising:
a first lens which is a meniscus lens with negative refractive power;
a second lens which is with refractive power and comprises a convex surface facing an object side;
a third lens which is with negative refractive power;
a fourth lens which is with positive refractive power;
a fifth lens which is a meniscus lens with refractive power and comprises a concave surface facing the object side and a convex surface facing an image side;
a sixth lens which is with refractive power and comprises a convex surface facing the object side;
a seventh lens which is with positive refractive power;
an eighth lens which is with negative refractive power;
a ninth lens which is with refractive power and comprises a convex surface facing the object side; and
a tenth lens which is with positive refractive power and comprises a convex surface facing the object side;
wherein the first lens, the second lens, the third lens, the fourth lens, the fifth lens, the sixth lens, the seventh lens, the eighth lens, the ninth lens, and the tenth lens are arranged in order from the object side to the image side along an optical axis.

12. The wide-angle lens assembly as claimed in claim 11, wherein:
the fifth lens is with positive refractive power and comprises a fifth front lens and a fifth rear lens, wherein the fifth front lens is a biconcave lens with negative refractive power and comprises a concave surface facing the object side and another concave surface facing the image side and the fifth rear lens is a biconvex lens with positive refractive power and comprises a convex surface facing the object side and another convex surface facing the image side;
the fifth front lens and the fifth rear lens are spaced apart without air gaps formed therebetween;
the sixth lens is with negative refractive power and comprises a sixth front lens and a sixth rear lens, wherein the sixth front lens is a biconvex lens with positive refractive power and comprises a convex surface facing the object side and another convex surface facing the image side and the sixth rear lens is with negative refractive power and comprises a concave surface facing the object side; and
the sixth front lens and the sixth rear lens are spaced apart without air gaps formed therebetween.

13. The wide-angle lens assembly as claimed in claim 12, wherein:
the sixth rear lens is a meniscus lens and further comprises a convex surface facing the image side;
the eighth lens comprises a concave surface facing the object side;
the ninth lens is a biconvex lens with positive refractive power and further comprises another convex surface facing the image side; and
the tenth lens is a biconvex lens and further comprises another convex surface facing the image side.

14. The wide-angle lens assembly as claimed in claim 13, wherein the wide-angle lens assembly satisfies at least one of following conditions:
$$6 \leq TTL / BFL \leq 9 ;$$
$$6 \leq TTL / IH \leq 10 ;$$
$$6.5 \leq TTL / f \leq 10.5 ;$$
$$- 7 \leq f 1 / f \leq - 3 ;$$
$$6 \leq f 9 / f \leq 15 ;$$
$$Vd 10 \leq 21 ;$$
$$9 \leq ( Vd 1 + Vd 2 + Vd 3 ) / Vd 4 \leq 11 ;$$
wherein TTL is an interval from an object side surface of the first lens to an image plane along the optical axis, BFL is an interval from an image side surface of the tenth lens to the image plane along the optical axis, IH is an image height of the wide-angle lens assembly, f is an effective focal length of the wide-angle lens assembly, f1 is an effective focal length of the first lens, f9 is an effective focal length of the ninth lens, Vd1 is an Abbe number of the first lens, Vd2 is an Abbe number of the second lens, Vd3 is an Abbe number of the third lens, Vd4 is an Abbe number of the fourth lens, and Vd10 is an Abbe number of the tenth lens.

15. The wide-angle lens assembly as claimed in claim 12, wherein:
the sixth rear lens is a biconcave lens and further comprises another concave surface facing the image side;
the eighth lens comprises a convex surface facing the object side;
the ninth lens is a meniscus lens and further comprises a concave surface facing the image side; and
the tenth lens is a biconvex lens and further comprises another convex surface facing the image side.

16. The wide-angle lens assembly as claimed in claim 15, wherein the wide-angle lens assembly satisfies at least one of following conditions:
$$6 \leq TTL / BFL \leq 9 ;$$
$$6 \leq TTL / IH \leq 10 ;$$
$$6.5 \leq TTL / f \leq 10.5 ;$$
$$- 7 \leq f 1 / f \leq - 3 ;$$
$$6 \leq f 9 / f \leq 15 ;$$
$$Vd 10 \leq 21 ;$$
$$9 \leq ( Vd 1 + Vd 2 + Vd 3 ) / Vd 4 \leq 11 ;$$
wherein TTL is an interval from an object side surface of the first lens to an image plane along the optical axis, BFL is an interval from an image side surface of the tenth lens to the image plane along the optical axis, IH is an image height of the wide-angle lens assembly, f is an effective focal length of the wide-angle lens assembly, f1 is an effective focal length of the first lens, f9 is an effective focal length of the ninth lens, Vd1 is an Abbe number of the first lens, Vd2 is an Abbe number of the second lens, Vd3 is an Abbe number of the third lens, Vd4 is an Abbe number of the fourth lens, and Vd10 is an Abbe number of the tenth lens.

17. The wide-angle lens assembly as claimed in claim 12, wherein:
the sixth rear lens is a biconcave lens and further comprises another concave surface facing the image side;
the eighth lens comprises a convex surface facing the object side;
the ninth lens is a meniscus lens and further comprises a concave surface facing the image side; and
the tenth lens is a meniscus lens and further comprises a concave surface facing the image side.

18. The wide-angle lens assembly as claimed in claim 17, wherein the wide-angle lens assembly satisfies at least one of following conditions:
$$6 \leq TTL / BFL \leq 9 ;$$
$$6 \leq TTL / IH \leq 10 ;$$
$$6.5 \leq TTL / f \leq 10.5 ;$$
$$- 7 \leq f 1 / f \leq - 3 ;$$
$$6 \leq f 9 / f \leq 15 ;$$
$$Vd 10 \leq 21 ;$$
$$9 \leq ( Vd 1 + Vd 2 + Vd 3 ) / Vd 4 \leq 11 ;$$
wherein TTL is an interval from an object side surface of the first lens to an image plane along the optical axis, BFL is an interval from an image side surface of the tenth lens to the image plane along the optical axis, IH is an image height of the wide-angle lens assembly, f is an effective focal length of the wide-angle lens assembly, f1 is an effective focal length of the first lens, f9 is an effective focal length of the ninth lens, Vd1 is an Abbe number of the first lens, Vd2 is an Abbe number of the second lens, Vd3 is an Abbe number of the third lens, Vd4 is an Abbe number of the fourth lens, and Vd10 is an Abbe number of the tenth lens.

19. The wide-angle lens assembly as claimed in claim 1, wherein:
the first lens comprises a convex surface facing the object side and a concave surface facing the image side;
the second lens is a meniscus lens with negative refractive power and further comprises a concave surface facing the image side;
the third lens is a biconcave lens and comprises a concave surface facing the object side and another concave surface facing the image side;
the fourth lens is a biconvex lens and comprises a convex surface facing the object side and another convex surface facing the image side;
the seventh lens is a biconvex lens and comprises a convex surface facing the object side and another convex surface facing the image side;
the eighth lens comprises a concave surface facing the image side; and
the ninth lens is with positive refractive power.

20. The wide-angle lens assembly as claimed in claim 19, wherein the wide-angle lens assembly satisfies at least one of following conditions:
$$6 \leq TTL / BFL \leq 9 ;$$
$$6 \leq TTL / IH \leq 10 ;$$
$$6.5 \leq TTL / f \leq 10.5 ;$$
$$- 7 \leq f 1 / f \leq - 3 ;$$
$$6 \leq f 9 / f \leq 15 ;$$
$$Vd 10 \leq 21 ;$$
$$9 \leq ( Vd 1 + Vd 2 + Vd 3 ) / Vd 4 \leq 11 ;$$
wherein TTL is an interval from an object side surface of the first lens to an image plane along the optical axis, BFL is an interval from an image side surface of the tenth lens to the image plane along the optical axis, IH is an image height of the wide-angle lens assembly, f is an effective focal length of the wide-angle lens assembly, f1 is an effective focal length of the first lens, f9 is an effective focal length of the ninth lens, Vd1 is an Abbe number of the first lens, Vd2 is an Abbe number of the second lens, Vd3 is an Abbe number of the third lens, Vd4 is an Abbe number of the fourth lens, and Vd10 is an Abbe number of the tenth lens.
